(19) United States
(12) Patent Application Publication
(10) Pub. No.: US 2025/0277703 A1
(43) Pub. Date: Sep. 4, 2025

(54) INFORMATION PROCESSING APPARATUS AND NON-TRANSITORY COMPUTER-READABLE STORAGE MEDIUM STORING INFORMATION PROCESSING PROGRAM

(71) Applicant: SEIKO EPSON CORPORATION, TOKYO (JP)

(72) Inventor: Shusuke KIBUNE, MATSUMOTO-SHI (JP)

(21) Appl. No.: 19/066,319

(22) Filed: Feb. 28, 2025

(30) Foreign Application Priority Data
Mar. 1, 2024 (JP) 2024-031391

(51) Int. Cl. G01J 3/52; H04N 1/60

(52) U.S. Cl. CPC G01J 3/52; H04N 1/6033

(57) ABSTRACT

Provided is an information processing apparatus including: an acquisition unit that acquires, from among a plurality of color materials, a specified color material, which is a specified color material, as a parameter for varying color values of color patches; and a generation unit that generates print data for printing a color chart including a first color patch and a second color patch, in which the first color patch and the second color patch differ in usage amount of the specified color material but have the same usage amounts of color materials other than the specified color material.

The present application is based on, and claims priority from JP Application Serial Number 2024-031391, filed Mar. 1, 2024, the disclosure of which is hereby incorporated by reference herein in its entirety.

### BACKGROUND

### 1. Technical Field

The present disclosure relates to an information processing apparatus and a non-transitory computer-readable storage medium storing an information processing program.

### 2. Related Art

Traditionally, a configuration is known in which a color chart including multiple patches is printed, and color adjustment is performed based on the color chart. For example, Japanese Patent No. 7314628 discloses a configuration in which multiple patches with different usage amounts of color materials, even with the same color value, are printed as a color chart (e.g., 0014-0016, FIG. 3, FIG. 10, etc.).

In the related art, it has not been possible to vary the color materials specified by the user when printing color patches with different color values. In the related art described above, color patches with different usage amounts of color materials are printed, but the color values of each color patch are the same. According to such a configuration, it is possible to compare, for example, multiple patches that have different usage amounts of fluorescent color materials but the same color value. However, it has not been possible to print color patches with different color values by varying the usage amounts of the color materials desired by the user.

### SUMMARY

An information processing apparatus according to an aspect includes: an acquisition unit that acquires, from among a plurality of color materials, a specified color material, which is a specified color material, as a parameter for varying color values of color patches; and a generation unit that generates print data for printing a color chart including a first color patch and a second color patch, the first color patch and the second color patch differ in usage amount of the specified color material but have the same usage amounts of color materials other than the specified color material.

A non-transitory computer-readable storage medium storing an information processing program, according to another aspect, the program causing a computer to function as: an acquisition unit that acquires, from among a plurality of color materials, a specified color material, which is a specified color material, as a parameter for varying color values of color patches; and a generation unit that generates print data for printing a color chart including a first color patch and a second color patch, the first color patch and the second color patch differ in usage amount of the specified color material but have the same usage amounts of color materials other than the specified color material.

### BRIEF DESCRIPTION OF THE DRAWINGS

FIG. 1 is a diagram illustrating a usage example of the information processing apparatus.

FIG. 2 is a block diagram of the colorimetric instrument.

FIG. 3 is a block diagram of the printing apparatus.

FIG. 4 is a block diagram of the information processing apparatus.

FIG. 5 is a flowchart of the print control process.

FIG. 6 is a diagram illustrating an example of the usage amount specification screen.

FIG. 7 is a diagram illustrating an example of the creation condition specification screen.

FIG. 8 is another diagram illustrating an example of the creation condition specification screen.

FIG. 9 is a diagram illustrating an arrangement example of color patches.

FIG. 10 is a diagram illustrating an example of a graphic printed together with color patches.

### DESCRIPTION OF EMBODIMENTS

Here, embodiments of the present disclosure will be described below in the following order:
(1) System Configuration
(1-1) Configuration of Colorimetric Instrument
(1-2) Configuration of Printing Apparatus
(1-3) Configuration of Information Processing Apparatus
(2) Print Control Process
(3) Other Embodiments, etc.

### (1) System Configuration

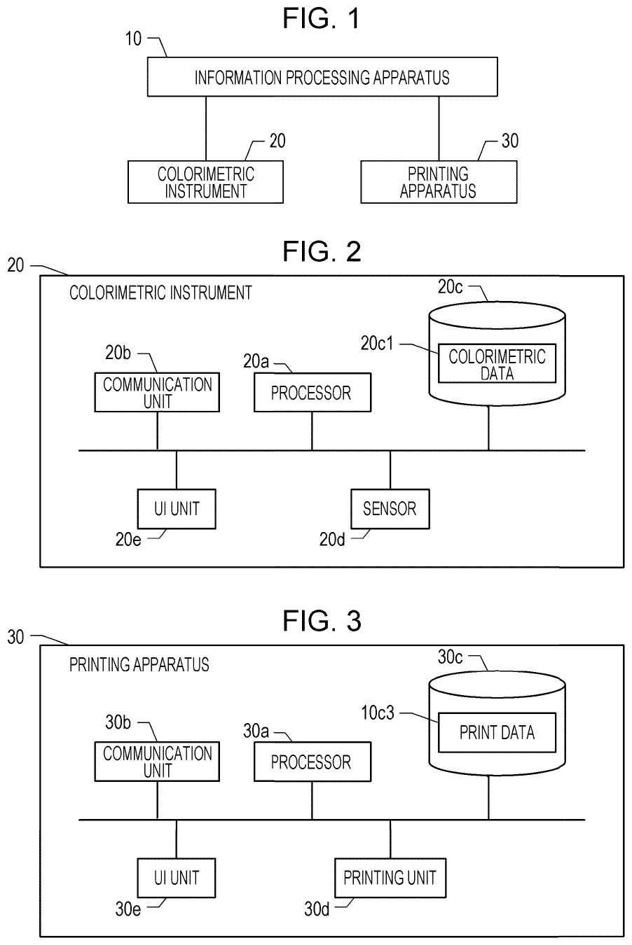

FIG. 1 is a diagram illustrating a usage example of the information processing apparatus 10 according to an embodiment. In the present embodiment, the information processing apparatus 10 is connected to a colorimetric instrument 20 and a printing apparatus 30. The information processing apparatus 10 is an apparatus that performs color conversion on image data to generate print data and causes the printing apparatus 30 to execute printing based on the print data. The user can also specify a desired color and print a color chart; and after confirming the color reproducibility based on the color chart, the user can execute printing of the desired image. In the present embodiment, the user can specify a reference color included in the color chart by measuring a color sample using the colorimetric instrument 20. The color chart includes a patch printed based on a color value indicating the reference color and patches printed based on the color values of surrounding colors generated by varying the color value of the reference color.

### (1-1) Configuration of Colorimetric Instrument

FIG. 2 is a block diagram illustrating the configuration of the colorimetric instrument 20. The colorimetric instrument 20 includes a processor 20a, a communication unit 20b, non-volatile memory 20c, a sensor 20d, and a UI unit 20e. The processor 20a includes an unillustrated CPU, ROM, RAM, etc., executes a control program recorded in the non-volatile memory 20c, and can control each unit of the colorimetric instrument 20.

The processor 20a may be configured with a single chip, multiple chips, or as an SoC with various functional blocks. For example, an ASIC may be employed instead of the CPU, or a configuration in which the CPU and ASIC cooperate may be employed. When each apparatus in the present embodiment includes a processor, the processor can be implemented in various ways, similar to the processor 20a.

The communication unit 20b includes a communication interface for communicating with the information processing apparatus 10 according to various wired or wireless communication protocols. The sensor 20d is a device that irradiates a colorimetric target with light of a predetermined color temperature and detects the spectral distribution of reflected light. The processor 20a acquires a color value (e.g., CIELAB value, HSV value, XYZ value, etc.) indicating the color of the colorimetric target by a color in a device-independent color space, based on the result read by the sensor 20d. Hereinafter, the description will continue assuming that the color value is an HSV value (hue value, saturation value, and brightness value).

In the present embodiment, the user can specify the color value of the reference color based on the colorimetric result of the colorimetric instrument 20. In the present embodiment, a sample color is measured by the colorimetric instrument 20 to specify the color value of the reference color. The sample color may be a color printed on various objects; however, here, it is assumed that a medium colored to be a sample color is measured. Thus, according to the configuration in which the reference color is specified by the colorimetric result of the colorimetric instrument 20, the reference color can be accurately specified.

In the present embodiment, when color matching is performed using the color chart, printing is performed so that the color value is reproduced for a specific single color; furthermore, the printing apparatus 30 can print colors similar to the color-matched color as colors reflecting the result of the color matching. Thus, in order to reflect the color matching result in multiple colors, in the present embodiment, the image data is composed of one or more layers.

In the present embodiment, each layer is called a plate. The number of color channels that can be used in each plate is predetermined; in the present embodiment, there is a process color plate that can be used by desirably varying any color over the entire range of gradation values, and a spot color plate for printing the color matched based on the color chart. The process color plate is a plate in which all usable colors can be desirably varied and used, and examples include image data in which all RGB (R: red, G: green, B: blue) can be used and image data in which all CMYK (C: cyan, M: magenta, Y: yellow, K: black) can be used.

Spot color plate image data consists of a representative color, which is the color representing the spot color plate, and colors with different densities from the representative color. In the spot color plate image data, the representative color is specified by each gradation value of RGB or CMYK in the header, and the color of each pixel is specified by a gradation value representing the relative density difference from the representative color. For example, when expressing the gradation value of a spot color plate with a 1-channel 8-bit gradation value, a gradation value of 128 matches the representative color, pixels with gradation values greater than 128 are considered darker than the representative color, and pixels with gradation values less than 128 are considered lighter than the representative color. A gradation value of 255 indicates the color when the representative color is made as dark as possible, and a gradation value of 0 indicates the color when the representative color is made as light as possible.

In the present embodiment, the representative color of the spot color plate is determined by the color matched using the color chart. That is, the user specifies the representative color by specifying one of the patches printed on the color chart. In the present embodiment, when a color sample is measured by the colorimetric instrument 20 to specify the reference color included in the color chart, the colorimetric data 20c1 indicating the color value, which is the colorimetric result, is stored in the non-volatile memory 20c.

The UI unit 20e is a button or the like provided on the housing of the colorimetric instrument 20. The user can instruct the start of color sample measurement, etc., by operating the UI unit 20e. The processor 20a receives the user's instruction based on the output information of the UI unit 20e.

### (1-2) Configuration of Printing Apparatus

FIG. 3 is a block diagram illustrating the configuration of the printing apparatus 30. The printing apparatus 30 includes a processor 30a, a communication unit 30b, non-volatile memory 30c, a printing unit 30d, and a UI unit 30e. The processor 30a includes an unillustrated CPU, ROM, RAM, etc., executes a control program recorded in the non-volatile memory 30c, and can control each unit of the printing apparatus 30.

The communication unit 30b includes a communication interface for communicating with the information processing apparatus 10 according to various wired or wireless communication protocols. The communication unit 30b may also include an interface for communicating with various removable memories attached to the printing apparatus 30.

The printing unit 30d includes actuators and various devices, sensors, drive circuits, mechanical parts, etc., for executing printing on a print medium. The sensors include sensors that detect various detection targets that can vary in the printing apparatus 30. Examples include a sensor that detects the remaining amount of print medium and a sensor that detects the remaining amount of each color material used for printing. In the present embodiment, the printing unit 30d includes a mechanism for recording color materials of predetermined colors on a print medium. In the present embodiment, the printing unit 30d records on the print medium using CMYKGGyROr (C: cyan, M: magenta, Y: yellow, K: black, G: green, Gy: gray, R: red, Or: orange) color materials. Hereinafter, it is assumed that the printing apparatus 30 is an ink jet printer that uses ink as the color material, but the printing method is not limited to the ink jet method. The color materials used for recording are not limited to the CMYKGGyROr combination and can be varied as appropriate.

The printing unit 30d can print on print media of various sizes. That is, the printing unit 30d includes a storage unit for storing print media of various sizes and can transport and print the stored print media.

The UI unit 30e is composed of an input unit such as buttons and a touch panel provided on the housing of the printing apparatus 30 and a display unit for displaying various information. Based on the information displayed on the display unit of the UI unit 30e, the user can operate the input unit to issue various instructions.

The processor 30a of the printing apparatus 30 performs printing based on the print data 10c3 transmitted from the information processing apparatus 10. That is, when printing is performed, the print data 10c3 is transmitted along with a print instruction from the information processing apparatus 10 and stored in the non-volatile memory 30c. Based on the print data 10c3, the processor 30a controls the printing unit 30d, etc., and executes printing on the print medium stored in the printing unit 30d.

### (1-3) Configuration of Information Processing Apparatus

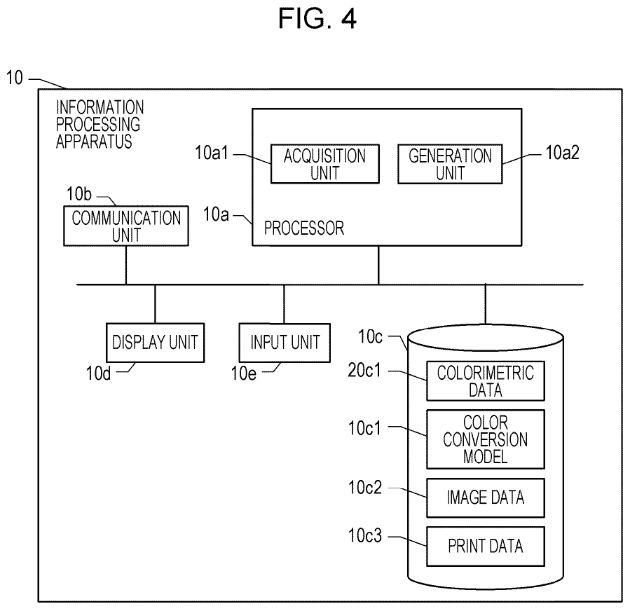

FIG. 4 is a block diagram illustrating the configuration of the information processing apparatus 10. In the present embodiment, the information processing apparatus 10 includes a processor 10a, a communication unit 10b, non-volatile memory 10c, a display unit 10d, and an input unit 10e. The processor 10a includes an unillustrated CPU, ROM, RAM, etc., executes various programs recorded in the non-volatile memory 10c, and can control each unit of the information processing apparatus 10, the colorimetric instrument 20, etc. In other words, the processor 10a functions as a control unit.

The communication unit 10b includes a communication interface for communicating with the colorimetric instrument 20 and the printing apparatus 30 according to various wired or wireless communication protocols. The communication unit 10b may also include an interface for communicating with various removable memories attached to the information processing apparatus 10.

Various data can be stored in the non-volatile memory 10c. In the present embodiment, colorimetric data 20c1, a color conversion model 10c1, image data 10c2, and print data 10c3 are stored in the non-volatile memory 10c. The colorimetric data 20c1 is data transmitted from the colorimetric instrument 20 and indicates the color value (HSV value), which is the colorimetric result of the sample color.

The color conversion model 10c1 is data for color-converting image data and associates colors in a device-independent color space with colors in a device-dependent color space. In the present embodiment, the color conversion model 10c1 includes an input-side model that performs input-side color conversion and an output-side model that performs output-side color conversion.

The input-side model that performs input-side color conversion is a model that converts RGB gradation values or CMYK gradation values indicating colors in a device-dependent color space and HSV values indicating colors in a device-independent color space into each other. In the present embodiment, a model for converting RGB gradation values or CMYK gradation values to HSV values is machine-learned. A model for converting HSV values to RGB gradation values or CMYK gradation values is also machine-learned based on the training data. These learned models are the input-side models. The form of the input-side model may be various; for example, it may be a neural network that converts input values to output values, or it may be composed of a machine-learned model and an optimization module that performs optimization, similar to the output-side model described later. It is also possible to use an existing ICC profile instead of the input-side model in the color conversion model 10c1. This ICC profile is a lookup table used for various devices; for example, in the present embodiment, a display profile corresponding to a display used as the display unit 10d can be used.

The output-side model that performs output-side color conversion is a model that converts colors in a device-dependent color space, i.e., CMYKGGyROr gradation values indicating the color materials used by the printing apparatus 30, and HSV values indicating colors in a device-independent color space into each other. In the present embodiment, the output model includes a model for converting the usage amounts of the color materials to color values (hereinafter referred to as a color prediction model) and an optimization module.

Here, the color prediction model includes a model for converting CMYKGGyROr gradation values indicating the usage amounts of the color materials into spectral reflectance. This model is generated, for example, by preparing training data in which CMYKGGyRor gradation values and spectral reflectance are associated in advance and machine-learning a neural network that converts CMYKGGyROr gradation values into spectral reflectance based on the training data. The spectral reflectance can be specified, for example, by measuring a color printed based on the CMYKGGyROr gradation values using the colorimetric instrument 20. The spectral reflectance can be converted into a color value by using a known calculation method, and the color prediction model also includes this conversion. Therefore, the color prediction model is a model that converts CMYKGGyROr gradation values into color values via spectral reflectance.

The optimization module is used to convert a color value to be converted into usage amounts of color materials using the color prediction model. Specifically, the optimization module converts a color value to be converted into provisional usage amounts of color materials, inputs them to the color prediction model, and converts them into a color value. The color value obtained by this conversion is called a predicted color value. If the color difference between the predicted color value and the color value to be converted is less than or equal to a reference value, the optimization module considers that the two match. In this case, the color value to be converted is converted into the provisional usage amounts of the color materials.

On the other hand, if the color difference between the predicted color value and the color value to be converted is greater than the reference value, the optimization module corrects the provisional usage amounts of the color materials. Furthermore, the optimization module inputs the corrected provisional usage amounts of the color materials to the color prediction model and determines whether or not the color difference between the obtained predicted color value and the color value to be converted is less than or equal to the reference value. The optimization module repeats the above process until the color difference between the predicted color value and the color value to be converted becomes less than or equal to the reference value. When the color difference between the predicted color value and the color value to be converted becomes less than or equal to the reference value, the optimization module considers that the color value to be converted has been converted into the provisional usage amounts of the color materials. As described above, according to the output-side model of the color conversion model 10c1, CMYKGGyROr gradation values can be converted into HSV values by the color prediction model. Also, HSV values can be converted into CMYKGGyROr gradation values by the color prediction model and the optimization module.

Further, in the present embodiment, constraint conditions for restricting the color materials used in the printing apparatus 30 can be imposed during conversion by the output-side model of the color conversion model 10c1. Specifically, when converting a color value to be converted into usage amounts of color materials, the optimization module sets provisional usage amounts of the color materials. At this time, it can be set so as not to use specific color materials. For example, when at least one of the CMYKGGyROr color materials is not used, the usage amount of that color material is fixed at 0. With this configuration, the optimization module specifies provisional usage amounts of the color materials such that the color difference between the predicted color value and the color value to be converted is less than or equal to the reference value while the usage amount of the color material is fixed at 0. Therefore, when provisional usage amounts of the color materials are specified such that the color difference between the predicted color value and the color value to be converted is less than or equal to the reference value, a color value can be converted into usage amounts of the color materials under the constraint of not using specific color materials. When converting usage amounts of color materials into a color value, the usage amounts of the unused color materials may be set to 0 and input to the prediction model.

The configuration in which color conversion is performed by the color conversion model 10c1 is merely an example, and color conversion may naturally be performed by various functions or lookup tables. However, by using the color conversion model 10c1, the resources required for the information processing apparatus 10 and the man-hours required for data generation can be reduced. For example, a lookup table is data in which HSV values and colors in a device-dependent color space are associated for multiple representative points, and the number of representative points is generally very large. In particular, when associating CMYKGGyROr gradation values with HSV values, the CMYKGGyROr gradation values are 8-dimensional coordinate values, and it is necessary to associate a large number of points in the 8-dimensional coordinate space with 3-dimensional HSV space coordinate values, resulting in a very large amount of data. In the case of a lookup table, in order to restrict color materials, it is necessary to create a lookup table for all cases after the restriction. For example, when restricting cyan or magenta, it is necessary to create a lookup table for each case.

On the other hand, although a large amount of data may be required when creating a learned model obtained by machine learning, the amount of data is generally less than that of a lookup table. Further, in the present embodiment, it is not necessary to create different learned models for each condition in order to restrict color materials. Therefore, assuming a situation where there are multiple conditions such that specific color materials are not used and a color conversion model 10c1 and a lookup table corresponding to each condition are prepared, the data amount can be reduced when preparing the color conversion model 10c1 compared to when preparing the lookup table.

The task of creating a lookup table generally requires a very large number of man-hours. The task of preparing lookup tables for each condition requires an extremely large number of man-hours. However, to generate the output-side model of the color conversion model 10c1 as in the present embodiment, it is not necessary to generate different models for each condition. Therefore, the color conversion model 10c1 can be generated with a smaller configuration than creating a lookup table.

The image data 10c2 is data indicating an image to be printed. As described above, the image data 10c2 includes image data of multiple plates. In the present embodiment, it is assumed that there is at least one process color plate and one spot color plate. Therefore, the image data 10c2 includes data of the process color plate in which the color of each pixel is specified by an RGB gradation value or a CMYK gradation value. The image data 10c2 also includes data of the spot color plate, including an RGB gradation value or a CMYK gradation value of a representative color specified in the header and a gradation value for each pixel indicating a relative density difference from the representative color. Naturally, this configuration is merely an example, and the number of plates that can exist is not limited, and multiple plates may exist or a specific plate may not exist. The image data 10c2 includes information indicating a weighting factor for superimposing each plate, and an image to be printed is specified by superimposing the data of each plate with the weighting factor.

The print data 10c3 is data for causing the printing apparatus 30 to execute printing. In the present embodiment, the processor 10a performs image processing including color conversion by the color conversion model 10c1 based on the image data 10c2 to generate the print data 10c3. Specifically, the image data 10c2 includes a printer description language, and the processor 10a performs rendering processing including analysis and conversion processing into raster data based on the printer description language. After rasterization, the processor 10a performs color conversion of the raster data using the color conversion model 10c1 and acquires the usage amount of each color material necessary to print the color of each pixel. For example, in the process color plate, the processor 10a converts the RGB value or CMYK value of each pixel into an HSV value by the input-side model or the ICC profile and converts the HSV value of each pixel into a CMYKGGyROr gradation value by the output-side model. In the spot color plate, the processor 10a acquires the CMYKGGyROr gradation value of each pixel based on the CMYKGGyROr gradation value of the representative color and the gradation value of each pixel. The processor 10a performs page layout determination processing, halftone processing, etc. on the print medium to generate the print data 10c3. When the print data 10c3 is generated, the print data 10c3 is transmitted to the printing apparatus 30, and printing is performed.

The display unit 10d is a display device that displays arbitrary images. The input unit 10e is a device on which the user performs input operations. The information processing apparatus 10 can be implemented in various ways and may be a stationary computer or a portable computer. In the former case, the display unit 10d can be configured, for example, with a display independent from the computer main body, and the input unit 10e can be configured, for example, with a keyboard, mouse, etc., independent from the computer main body. In the latter case, the display unit 10d and the input unit 10e can be configured, for example, with a touch panel display integrated with the computer main body. In any case, the user can input the user's intention by operating the input unit 10e while visually recognizing images and characters displayed on the display unit 10d. Hereinafter, in the present embodiment, the description will be given assuming that the information processing apparatus 10 is a stationary computer.

The processor 10a can execute an unillustrated information processing program. The information processing program according to the present embodiment displays a screen for setting when printing a spot color plate so as to reproduce the sample color measured by the colorimetric instrument 20 on the display unit 10d. The user can use this screen to print a color chart including patches of the reference color (details below) and surrounding colors, and the user can specify the representative color of the spot color plate by selecting a patch on the color chart.

In the present embodiment, the information processing program has a function for performing color matching using the color chart. When the information processing program is executed, the processor 10a functions as an acquisition unit 10a1 and a generation unit 10a2.

The acquisition unit 10a1 has a function of acquiring parameters for varying the color values of color patches. The user can select the parameters from among multiple color materials and components of color values (hue, saturation, and brightness).

The generation unit 10a2 has a function of generating print data for printing a color chart. That is, the generation unit 10a2 generates print data 10c3 for printing the color chart including the reference color and surrounding colors and stores it in the non-volatile memory 10c.

Specifically, the acquisition unit 10a1 receives information for specifying the color value of each of the multiple color patches from the user. In the present embodiment, the processor 10a acquires the color value (HSV value) of the sample color measured by the colorimetric instrument 20 and converts the color value into the usage amount of each color material by the output-side model of the color conversion model 10c1. The HSV value is a value of the device-independent color space.

The user can correct the usage amount for each color material and restrict the color materials to be used by inputting to a screen, which will be described later, and can specify the desired usage amount for each desired color material. The color specified in this manner is the reference color. When the designation of the reference color is received, the user specifies a parameter to be varied from among the parameters that specify the color. The parameter to be varied is called a variation parameter. The variation parameter may be various parameters, and in the present embodiment, the user can select three variation parameters from among hue, saturation, brightness, and color materials. The acquisition unit 10a1 acquires the variation parameters specified by the user. Here, when any of hue, saturation, and brightness, which are components of the color value, is specified, the specified component is called a specified component; when the usage amount of a color material is specified, the specified color material is called a specified color material.

The user further specifies the variation range of the values in the specified component and specified color material that are the variation parameters. The acquisition unit 10a1 acquires the variation range specified by the user. The generation unit 10a2 selects one variation parameter and generates surrounding colors by varying the value of the selected variation parameter among the parameter values of the reference color or the surrounding color according to the variation range. The generation unit 10a2 does not vary the values of the unselected parameters.

For example, when varying the specified color material, the generation unit 10a2 fixes the usage amounts of the color materials other than the specified color material among the color materials used when printing the reference color, varies the usage amount of the specified color material according to the variation range, and generates surrounding colors. When varying the specified component, the generation unit 10a2 fixes the values of the components other than the specified component among the components of the color value indicating the reference color, varies the value of the specified component according to the variation range, and generates surrounding colors. When surrounding colors are generated as described above, the generation unit 10a2 further performs the same processing, varies the usage amounts of the color materials or the color values by varying the value of one variation parameter according to the variation range among the parameter values of the surrounding colors while fixing other parameters, and generates surrounding colors.

The number of surrounding colors generated according to the variation range may be fixed or specified by the user. When the specified color material is included among the variation parameters, the generation unit 10a2 converts the usage amount of the specified color material into a color value based on the output-side model of the color conversion model 10c1. According to the above configuration, the user can generate surrounding colors by varying the reference color in a desired manner.

When the color values of the reference color and surrounding colors are specified, each color is considered to be a color value indicating the color of multiple color patches. That is, according to the above processing, the color values of multiple color patches are acquired. When two color patches are extracted from the multiple color patches in the case where the specified color material is used as a variation parameter, one can be considered as a first color patch and the other can be considered as a second color patch. That is, the first color patch and the second color patch differ in the usage amount of the specified color material but have the same usage amounts of the color materials other than the specified color material. The first color patch and the second color patch may be any color patch on the color chart, the reference color may be the first color patch or the second color patch, and the surrounding color may be the first color patch and/or the second color patch.

When the user issues a print instruction while the print data 10c3 is generated, the processor 10a transmits the print data 10c3 to the printing apparatus 30 via the communication unit 10b. The printing apparatus 30 receives the print data 10c3 via the communication unit 30b and executes printing based on the print data 10c3. As a result, the color chart including the reference color and surrounding colors is printed. The user compares the color patches of the color chart, specifies a desired color patch, and specifies the identification information by the input unit 10e.

The processor 10a specifies the color patch based on the identification information specified by the user, specifies the color value and the usage amount of each color material of the color patch, and acquires it as the representative color of the spot color plate. That is, the color value or the usage amount of each color material is recorded in the header indicating the representative color of the spot color plate.

As a result, the user's settings are reflected in subsequent printing of the spot color plate. Specifically, when printing the spot color plate, the representative color is printed in the color of the color patch specified by the user. Colors other than the representative color are printed as colors with the density of the color patch specified by the user increased or decreased based on the gradation value associated with the pixel. According to the above configuration, the user can designate a desired color material as the specified color material, vary the usage amount of the specified color material relative to the reference color, and generate patches of surrounding colors without varying the usage amounts of the color materials other than the specified color material. The color patches generated in the manner described above differ in the usage amounts of the specified color materials but have the same usage amounts of the color materials other than the specified color materials, so that the color values when the color patches are printed are different.

Therefore, according to the present embodiment, it is possible to print color patches with different color values by changing the usage amounts of the color materials desired by the user. Further, according to the present embodiment, it is possible to print color patches with different color values by changing the values of the components of the color values desired by the user. Thus, in the present embodiment, color patches can be generated by varying both the color materials and the color values desired by the user. Since the color values according to the present embodiment are parameters that are easy for the user to intuitively understand, such as hue, saturation, and brightness, it is easy for the user to intuitively estimate what kind of color will be obtained by varying which component by how much when varying the color values.

On the other hand, when changing the usage amount of color materials, the change in the color value due to an increase or decrease in the usage amount is generally complex, and it is difficult to generate a patch with a desired color value by specifying a specific color material and adjusting the usage amount. However, if it is possible to specify a color material and adjust the usage amount, it becomes possible, for example, to reduce a specific color material as much as possible because it stands out as granular, and to try whether or not the color becomes the color desired by the user. According to the above configuration, it is possible to easily make adjustments, for example, such as intuitively adjusting the color based on the color value and further increasing or decreasing the usage amount of a specific color material.

Further, in the present embodiment, surrounding colors are generated by varying the usage amount of the specified color material or the value of the specified component relative to the reference color. Therefore, it is clear what color is used as a reference and how the color is varied to generate the surrounding colors, which facilitates varying the color in a desired manner.

Further, in the present embodiment, the user can instruct the variation range for varying the specified color material and the variation range for varying the specified component. Therefore, it is possible to generate surrounding colors by varying the color in a manner desired by the user.

### (2) Print Control Process

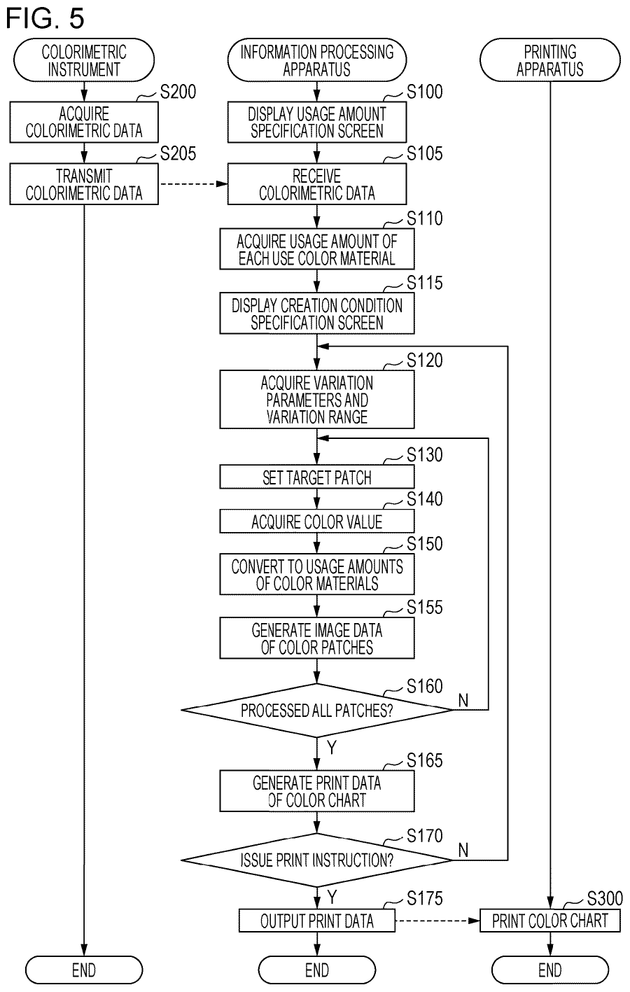

Next, the color chart print control process will be described in detail with reference to the flowchart shown in FIG. 5. The user prepares the image data 10c2 to be printed and stores it in the non-volatile memory 10c before starting the print control process. When starting printing, the user operates the input unit 10e of the information processing apparatus 10 to cause the processor 10a to execute the print control program.

When the print control program starts, the processor 10a of the information processing apparatus 10 controls the display unit 10d to display a usage amount specification screen (step S100). The usage amount specification screen is a screen for specifying the color value of the reference color and the usage amount of each color material used when the reference color is printed by the printing apparatus 30.

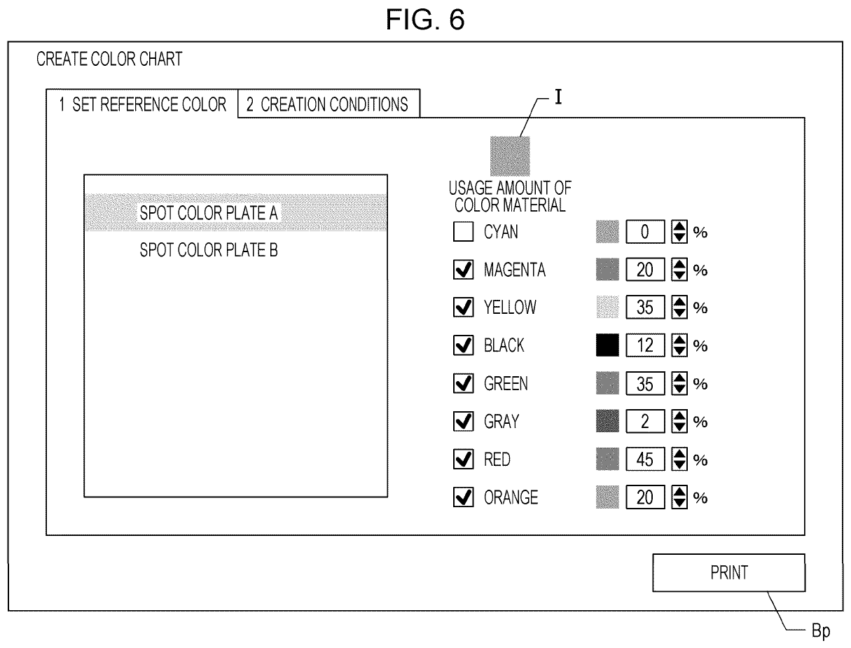

FIG. 6 illustrates an example of the usage amount specification screen. On this screen, a character string indicating that it is a screen for creating a color chart is displayed at the top, and the screen can be switched by two tabs shown below it. There are tabs for setting the reference color and for specifying color creation conditions. The screen shown in FIG. 6 illustrates a state where the tab for setting the reference color is selected, and this screen is the default display screen of the usage amount specification screen.

In the example illustrated in FIG. 6, a character string indicating the applicable spot color plate is displayed on the left side of the screen, and information on the reference color is displayed on the right side of the screen. On the left side of the screen, the spot color plates included in the image data 10c2 are listed, and the selected spot color plate is colored gray. On the right side of the screen, an icon I simulating the reference color is displayed at the top, and a user interface for specifying the usage amount of each color material is displayed at the bottom. The icon I simulating the reference color is a rectangular sample simulating the color corresponding to the color value indicating the reference color and is not displayed on the initial screen.

In the user interface for specifying the usage amount of each color material, the names of the color materials usable in the printing apparatus 30 are displayed in a list, and checkboxes for specifying whether or not to use each color material are associated with the names of the color materials. The color materials specified as color materials to be used by the checkboxes are referred to as use color materials. Icons simulating the colors of the color materials and input boxes indicating the usage amounts of the color materials are associated with the names of the color materials. The usage amount of each color material can be specified as any value from 0 to 100%, but no numerical value is displayed on the initial screen. In the present embodiment, the % value indicating the usage amount of each color material and the gradation value are associated with each other in advance. Naturally, the usage amount of each color material may be specified by a gradation value.

The user can specify the color values in various ways to specify the reference color, but in this example, the color values is acquired by using the colorimetric result by the colorimetric instrument 20. Therefore, the user operates the colorimetric instrument 20 to measure the sample color. When the colorimetric measurement is performed, the processor 20a of the colorimetric instrument 20 acquires the colorimetric data 20c1 (step S200) and stores it in the non-volatile memory 20c.

Next, the processor 20a of the colorimetric instrument 20 transmits the colorimetric data 20c1 to the information processing apparatus 10 via the communication unit 20b (step S205). By the function of the generation unit 10a2, the processor 10a of the information processing apparatus 10 receives the colorimetric data 20c1 via the communication unit 10b (step S105) and stores it in the non-volatile memory 10c. Furthermore, the processor 10a refers to the input-side model of the color conversion model 10c1 and converts the HSV value indicated by the colorimetric data 20c1 into an RGB gradation value. The processor 10a then controls the display unit 10d and displays the icon I with the RGB gradation value.

Next, the generation unit 10a2 acquires the usage amount of each use color material (step S110). The user determines the use color materials, operates the input unit 10e, and checks the checkboxes displayed on the right side of the usage amount specification screen illustrated in FIG. 6. According to this configuration, the user can specify all or part of the color materials usable in the printing apparatus 30 as use color materials. The generation unit 10a2 acquires the checked color materials as use color materials. The unchecked color materials are not acquired as use color materials, and their use is prohibited when printing the color patches. That is, the presence or absence of checks in the checkboxes defines a constraint condition of using the use color materials and not using the color materials that are not use color materials.

Further, the generation unit 10a2 refers to the output-side model of the color conversion model 10c1 and converts the color value acquired in step S105 into the usage amount of each use color material under the constraint condition that the use color materials are used and the color materials other than the use color materials are not used. The generation unit 10a2 controls the display unit 10d and causes the usage amounts obtained by conversion to be displayed in input boxes that indicate the usage amounts of color materials. Note that the user may correct the usage amounts in the input boxes by operating the input unit 10e. When the usage amounts are corrected by the user, the generation unit 10a2 refers to the output-side model of the color conversion model 10c1, converts the usage amounts of each color material to color values, and treats them as the color values of the reference color. According to the above configuration, it is possible to specify the usage amounts of color materials to reproduce the color value acquired in step S105 in a state where the use color materials are used and the color materials other than the use color materials are not used.

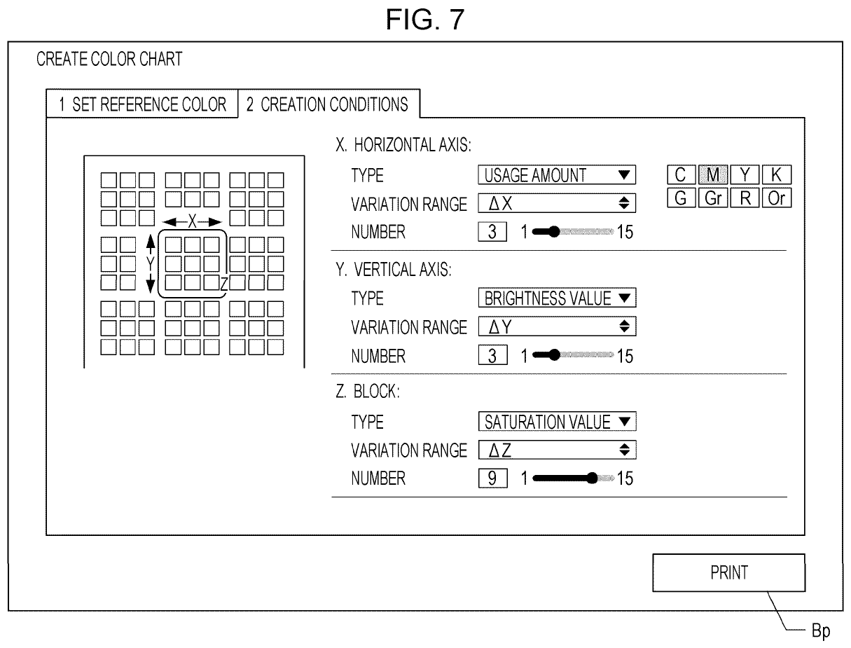

Next, the user operates the input unit 10e and selects the tab for specifying the color creation conditions illustrated in FIG. 6. In response to the selection, the acquisition unit 10a1 displays the creation condition specification screen (step S115). FIG. 7 illustrates an example of the creation condition specification screen. In the example illustrated in FIG. 7, a diagram schematically illustrating the color chart is displayed on the left side of the screen, and a user interface for specifying creation conditions when varying the reference color to generate surrounding colors is displayed on the right side of the screen.

In the example illustrated in FIG. 7, the user interface is a screen for setting each of the three variation parameters. The letters X, Y, and Z are respectively associated with the three variation parameters. A type, a variation range, and a number are associated with each variation parameter, and the user can specify the content of each parameter. The type is the type of variation parameter, and by selecting the type, the user can specify which parameter of the color representing the reference color should be varied. In the present embodiment, the user can specify any three of the hue, the saturation, and the brightness of color materials as the variation parameters. When the variation parameter is the color materials, the color of the color material to be varied can be selected. In the example illustrated in FIG. 7, magenta is selected.

The variation range is the amount of one step when the value of the variation parameter is changed stepwise. For example, the user can specify the variation range using a percentage of usage amount, a hue value, or the like. In this specification, it is assumed that the usage amount of color materials is expressed as a percentage, with the upper limit of usage amount for each color material being 100% and the state where the color material is not used being 0%, but usage amounts may be expressed using other methods, such as gradation values. The number indicates the number of color patches generated by changing the variation parameters. The user can specify the number by numerical value or slide bar.

When the variation range and the number are specified, the configuration is determined in which the color patches are arranged. Specifically, the variation parameter associated with X is a parameter that varies when the position of the color patch varies in the horizontal direction, and the variation parameter associated with Y is a parameter that varies when the position of the color patch varies in the vertical direction. These X and Y correspond to the horizontal and vertical axes, and the color patches generated by varying the variation parameter associated with X are arranged horizontally by the number specified for the variation parameter. The color patches generated by varying the variation parameter associated with Y are arranged vertically by the number specified for the variation parameter.

In the above configuration, the horizontal axis (X-axis) to which X is assigned can be considered as the first axis, and the vertical axis (Y-axis) to which Y is assigned can be considered as the second axis. In the present embodiment, the user can arbitrarily select parameters corresponding to the first axis and the second axis. Therefore, when the user designates the specified color material as the parameter corresponding to the first axis and the specified component as the parameter corresponding to the second axis, the generation unit 10a2 changes the usage amount of the specified color material in the color patches arranged along the first axis, and changes the value of the specified component in the color patches arranged along the second axis.

When the user designates the specified color material as the parameter corresponding to the first axis and also designates the specified color material as the parameter corresponding to the second axis, the acquisition unit 10a1 receives a first specified color material and a second specified color material as the specified color material. In this case, the generation unit 10a2 changes the usage amount of the first specified color material in the color patches arranged along the first axis, and changes the usage amount of the second specified color material in the color patches arranged along the second axis. According to this configuration, color patches can be generated by varying multiple color materials desired by the user.

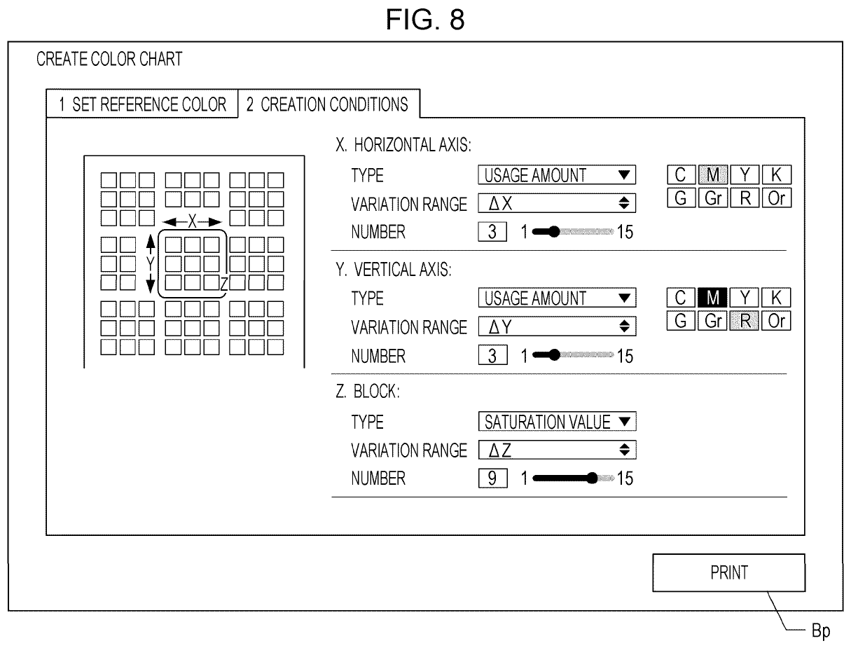

In this case, it is preferable that the acquisition unit 10a1 prevents the same color material from being specified for different axes. FIG. 8 illustrates an example of the creation condition specification screen when the first specified color material and the second specified color material are received. FIG. 8 assumes an example where the user selects to change the usage amount of magenta on the horizontal axis to which X is assigned. When the user selects usage amount for another axis, the acquisition unit 10a1 displays a box for specifying the color material so that the color of the color material to be changed can be selected. However, in the example illustrated in FIG. 8, since magenta has already been selected, the box is displayed so that magenta cannot be selected. In the example illustrated in FIG. 8, in the box for designating the specified color material for the vertical axis to which Y is assigned, magenta is displayed in a box with white characters on a black background, indicating that it cannot be selected. FIG. 8 also shows an example in which the specified color material for the vertical axis to which Y is assigned is red.

In this specification, the color patches arranged vertically and horizontally by the specified numbers are called a block. For example, when the numbers are specified as 3 for both the variation parameter associated with X and the variation parameter associated with Y, 3 color patches are arranged vertically and horizontally in one block. In the example illustrated in FIG. 7, the block located in the center is surrounded by a solid line and displayed with the letter Z attached. The variation parameter associated with Z is a parameter that varies in different blocks. That is, the color patches including multiple blocks printed on the color chart may be configured to differ from each other in the value of the variation parameter associated with Z.

When such color patches are compared with each other, the variation parameters associated with X, Y, and Z each vary by the variation range. For example, the colors of horizontally adjacent color patches have a color difference of the variation range in the value of the variation parameter associated with X. The colors of vertically adjacent color patches have a color difference of the variation range in the value of the variation parameter associated with Y. Furthermore, by varying the value of the variation parameter associated with Z by the variation range, colors included in different blocks are generated.

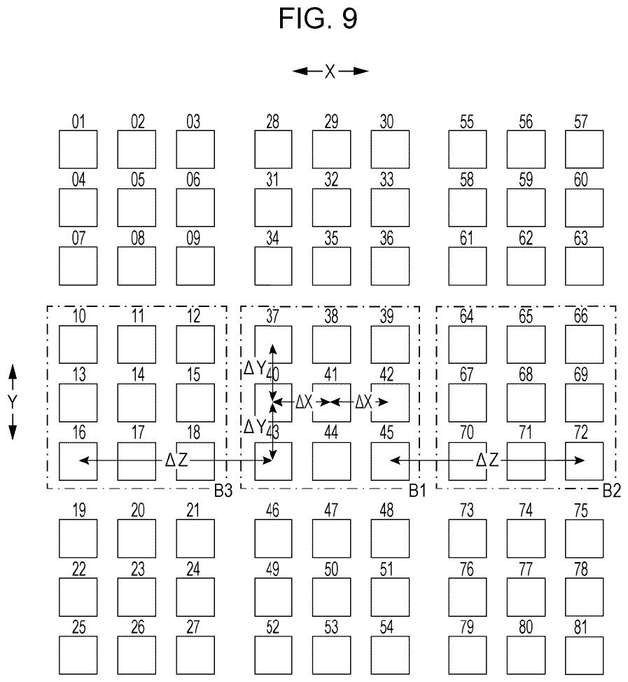

FIG. 9 illustrates an arrangement example of color patches generated when the settings for X, Y, and Z are the example illustrated in FIG. 7. In this example, since the numbers for X and Y are 3 and 3, respectively, the number of color patches arranged in one block is 9. In the example illustrated in FIG. 9, numerical values (01 to 81), which serve as identification information, are printed in association with each color patch.

In the color patches illustrated in FIG. 9, the color patch with the identification information 41 arranged in the center is the reference color color patch. The block B1 including the reference color is composed of 9 color patches. In the horizontal direction, the usage amount of magenta, which is the variation parameter associated with X, varies by the variation range ΔX. Therefore, for example, the color patch with the identification information 42 is printed with a magenta usage amount that is greater than that of the reference color by ΔX, and the color patch with the identification information 40 is printed with a magenta usage amount that is less than that of the reference color by ΔX.

For example, assume a case where the usage amount of magenta, which is the specified color material, is 20% in the reference color with identification information 41, and the color materials other than the specified color material are cyan and yellow, with respective usage amounts of 50%. It is also assumed that the variation range of magenta, which is the specified color material, is 10%. In this case, in the surrounding color with identification information 40, the usage amount of magenta is 10% and the usage amounts of cyan and yellow are 50%. On the other hand, in the surrounding color with identification information 42, the usage amount of magenta is 30% and the usage amounts of cyan and yellow are 50%.

In the vertical direction, the brightness value, which is the variation parameter associated with Y, varies by the variation range ΔY. Therefore, for example, the color patch with the identification information 37 is printed with a usage amount corresponding to a color value with a brightness value greater than that of the color patch with the identification information 40 by ΔY, and the color patch with the identification information 43 is printed with a usage amount corresponding to a color value with a brightness value less than that of the color patch with the identification information 40 by ΔY.

Further, in the color patches illustrated in FIG. 9, 9 blocks are arranged, and in each block, the saturation value, which is the variation parameter associated with Z, varies by the variation range ΔZ. Therefore, for example, the color patch with the identification information 72 in the block B2 is printed with a usage amount corresponding to a color value with a saturation value greater than that of the color patch with the identification information 45 in the block B1 by ΔZ, and the color patch with the identification information 16 in the block B3 is printed with a usage amount corresponding to a color value with a saturation value less than that of the color patch with the identification information 43 in the block B1 by ΔZ. The dashed-dotted lines indicating the blocks, character strings B1, B2, B3, ΔX, ΔY, ΔZ, and arrows in FIG. 9 are for explanation and are not printed on the color chart.

Returning to FIG. 5, the description will be continued. To generate the print data 10c3 for the color chart as described above, the acquisition unit 10a1 receives the input content of the creation condition specification screen. The generation unit 10a2 then sets one of the color patches as a target patch and performs the processing of steps S130 to S160 on the target patch, based on the input content. Specifically, the acquisition unit 10a1 sets the target patch (step S130). The target patch is one of the color patches printed on the color chart and is a color patch that has not been subjected to the loop processing of steps S130 to S160.

The target patch is set by, for example, the following processing. The generation unit 10a2 acquires the total number of color patches printed on the color chart based on the number specified for each of the three variation parameters corresponding to X, Y, and Z. The generation unit 10a2 then associates identification information with each of these color patches. Furthermore, the generation unit 10a2 sorts the color patches based on the identification information and sequentially selects identification information that has not been subjected to the loop processing of steps S130 to S160 and sets it as the target patch.

Next, the generation unit 10a2 acquires the color value of the target patch (step S140). That is, the generation unit 10a2 acquires the color value and usage amount of each color material acquired in steps S100, S105, and S110 for the reference color. Furthermore, the generation unit 10a2 specifies the variation range of the variation parameter to be varied from the reference color and the number of variations with the variation range, based on the variation range specified in step S120.

For example, in the example illustrated in FIGS. 7 and 9, when the target patch is the color patch with the identification information 45, the generation unit 10a2 specifies the usage amount when the usage amount of magenta of the reference color is increased once by the variation range ΔX. Furthermore, the generation unit 10a2 refers to the output-side model of the color conversion model 10c1 and converts the obtained usage amounts of each color material into a color value. Furthermore, the generation unit 10a2 decreases the obtained color value once by the variation range ΔY and considers it as the color value of the target color patch with the identification information 45. When the target patch is the color patch with the identification information 72, for example, the generation unit 10a2 increases the saturation value of the color patch with the identification information 45 once by the variation range ΔZ and considers it as the color value of the target color patch with the identification information 72.

When the color value of the target patch is acquired, the generation unit 10a2 converts the color value into usage amounts of color materials (step S150). That is, the generation unit 10a2 refers to the output-side model of the color conversion model 10c1 and converts the color value into usage amounts of color materials.

Next, the generation unit 10a2 generates image data of the color patches (step S155). Specifically, the generation unit 10a2 generates image data to print uniform rectangular color patches of a predetermined size using each color material with the usage amounts acquired in step S150.

Next, the generation unit 10a2 determines whether or not all the patches have been processed (step S160). That is, the generation unit 10a2 determines that all patches have been processed when the processing of steps S130 to S160 has been performed on all color patches printed on the color chart as target patches. If it is determined in step S160 that all patches have not been processed, the processor 10a repeats the processing from step S130 onward.

On the other hand, if it is determined in step S160 that all the patches have been processed, the generation unit 10a2 generates the print data 10c3 of the color chart (step S165). Specifically, the generation unit 10a2 arranges the color patch images generated in step S155 in the order illustrated in FIG. 9. That is, the generation unit 10a2 arranges the color patches so that when the position varies to the next position in the horizontal direction, the variation parameter corresponding to X varies by the variation range, and when the position varies to the next position in the vertical direction, the variation parameter corresponding to Y varies by the variation range. In this way, blocks are formed. The generation unit 10a2 arranges the blocks so that the variation parameter corresponding to Z varies by the variation range between adjacent blocks. Furthermore, the generation unit 10a2 generates the print data 10c3 so that the usage amount of each color material in each color patch is the usage amount acquired in step S155.

Next, the generation unit 10a2 determines whether or not a print instruction has been issued (step S170). Specifically, when the user operates the input unit 10e and issues an instruction using the print button Bp illustrated in FIGS. 6 and 7, the generation unit 10a2 determines that a print instruction has been issued. If it is determined in step S170 that a print instruction has been issued, the generation unit 10a2 outputs the print data 10c3 (step S175). That is, the generation unit 10a2 outputs the print data 10c3 to the printing apparatus 30 via the communication unit 10b.

The processor 30a of the printing apparatus 30 acquires the print data 10c3 via the communication unit 30b and prints the color chart (step S300). The user compares the color patches printed on the color chart, selects a desired color patch, operates the input unit 10e, and inputs the identification information of the selected color patch. The processor 10a considers that the representative color is specified by the color value and usage amounts of color materials of the color patch corresponding to the input identification information. According to the above configuration, the user's desired color can be set as the representative color of the spot color plate.

### (3) Other Embodiments, Etc.

The above embodiments are merely examples for carrying out the present disclosure, and various other embodiments can be adopted. For example, the information processing apparatus 10 and other devices (at least one of the colorimetric instrument 20 and the printing apparatus 30) may be provided integrally. The connection mode of each apparatus is not limited to the configuration shown in FIG. 1, and communication between any devices may be performed via any network. Furthermore, at least some of the functions of each apparatus may be distributed among multiple apparatuses; for example, at least some of the functions of the information processing apparatus 10 may be implemented by a cloud server. Also, at least some of the functions of the information processing apparatus 10 may be implemented by other apparatuses to form an information processing system. The flowchart and screen configurations described above are only examples, and other configurations may be employed, other configurations may be added, or some configurations may be omitted. For example, a configuration that allows specifying unused color materials, as in FIG. 6, may be omitted.

The acquisition unit only needs to be able to acquire, from among multiple color materials, a specified color material, which is a specified color material, as a parameter for varying the color values of the color patches. That is, the user can specify any of multiple color materials usable in the printing apparatus as a specified color material. Further, the specified color material becomes a parameter for changing the color value of the color patches printed on the color chart. Therefore, the first and second color patches differ in the usage amount of the specified color material, and as a result, their color values differ.

The color material may be any material that colors the print medium with the printing apparatus and is not limited to ink, and may be toner or the like. Further, the color materials that can be used in the printing apparatus can be distinguished by the color (hue) of the color materials; however, even if inks of the same color system have different shades and can be used distinctively, they may be distinguished as different color materials. Furthermore, when the color materials are stored in cartridges, color materials stored in different cartridges may be distinguished as different color materials.

The specified color material may be specified in various ways, for example, by the name of the color of the color material, an icon indicating the color material, a code, or the like. The specified color materials are color materials designated by the user, and one or more color materials are designated from among multiple color materials. Multiple specified color materials may be designated. When multiple specified color materials are designated, multiple color patches are printed so that the usage amount varies in one of the multiple specified color materials but the usage amounts of the other color materials do not vary. In such multiple color patches, for each of the multiple specified color materials, color patches are generated so that one usage amount varies and the usage amounts of the other color materials do not vary. The color value may be any value that indicates a color, and in addition to coordinate values in the color space, for example, spectral reflectance may be used as the color value.

The generation unit only needs to be able to generate print data for printing a color chart including the first color patch and the second color patch. However, the first color patch and the second color patch differ in the usage amount of the specified color material but have the same usage amounts of the color materials other than the specified color material. That is, the usage amount of the specified color material varies between the first color patch and the second color patch, but the usage amounts of the color materials other than the specified color material do not vary. The number of patches included in the color chart is not limited to two and may be three or more.

The first axis and the second axis only need to correspond to the directions in which the color patches are arranged. Therefore, in addition to the horizontal axis (X-axis) and vertical axis (Y-axis) as in the above embodiment, an axis such as a virtually assumed Z-axis may be included.

The reference color may be any color that serves as a reference when changing the color values of the color patches, and the color of the color patches may be changed by changing the value of the specified parameter relative to the reference color. Therefore, the reference color is not limited to the color representing the spot color plate. For example, a specific color included in the process color plate may be the reference color. The method for acquiring the color value of the reference color may be any of various methods. Therefore, in addition to the configuration in which the color of the color sample is measured for the reference color, various configurations may be employed. For example, a color value may be associated with an identification number of the color sample, and the color value may be acquired based on the identification number. The color value may also be designated by the user. The color value may be any value that indicates a color, and in addition to coordinate values in the color space, spectral reflectance may be used as the color value.

Furthermore, icons, characters, etc., for making it easier for the user to recognize the variation parameters may be printed on the color chart. For example, a graphic indicating that the usage amount of the specified color material has changed may be printed on the color chart. More specifically, in the configuration described above, the generation unit 10a2 may generate a graphic including a portion that uses the specified color material and does not use color materials other than the specified color material, and print it on the color chart next to the first color patch and the second color patch.

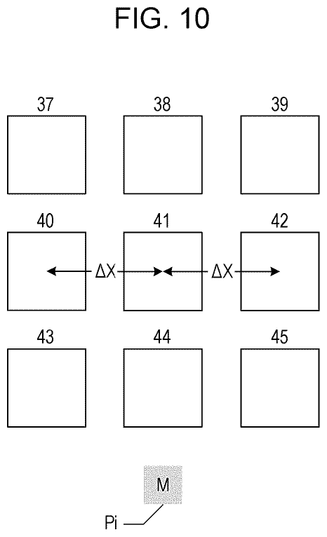

FIG. 10 illustrates an example of such a graphic. FIG. 10 is a diagram illustrating an extracted block B1 in an example where the graphic is printed along with the color chart illustrated in FIG. 9. In FIG. 10, the usage amount of magenta, which is the specified color material, is varied between color patches adjacent in the horizontal direction, which is the X-axis. Therefore, the generation unit 10a2 generates a rectangular graphic Pi including a portion that uses the specified color material and does not use the color materials other than the specified color material, i.e., a portion with a single color of the specified color material, and prints it on the color chart. In this example, since two color patches arranged in the X-axis direction can be considered as the first color patch and the second color patch, the graphic Pi is printed next to the first color patch and the second color patch.

In the example illustrated in FIG. 10, since the graphic Pi includes a portion of a single magenta color, the user can easily recognize that the usage amount of magenta changes along the X-axis direction. In this configuration, the greater the number of usable color materials, the greater the effect. For example, since the printing apparatus 30 according to the above embodiment can use eight colors, CMYKGGyROr, when the specified color material is red, it is difficult to distinguish by visual observation of the color patches whether magenta, orange, etc., are varied or red is varied. It is particularly difficult to distinguish when fine-tuning the usage amount of the color materials. Therefore, when the specified color material is clearly indicated by the graphic Pi, the user can easily recognize the specified color material and its direction of variation without having to remember the axis corresponding to the specified color material.

In the example illustrated in FIG. 10, the graphic Pi includes the letter M, which indicates magenta, the specified color material. The character may be printed in a color other than the specified color material, such as black. According to this character, the user can more easily recognize that the usage amount of magenta varies along the X-axis direction. Naturally, information to more clearly indicate the direction in which the specified color material varies, which is the X-axis direction in the example illustrated in FIG. 10, such as an arrow indicating the X-axis, may be printed together.

Furthermore, the color conversion model 10c1 is generated by performing colorimetric measurement or machine learning in advance; however, some users may use the printing apparatus 30 in a state where the color conversion model 10c1 has not been generated yet; in such cases, some functions may be restricted. For example, when the color conversion model 10c1 has not been generated, the processor 10a may determine that it cannot acquire the usage amount of the color material corresponding to an arbitrary color value, and may disable selection of the components of the color value as variation parameters. In this case, the acquisition unit 10a1 accepts the usage amount of the color materials as a variation parameter. The acquisition unit 10a1 receives the user's specification of the usage amount of the color materials in the reference color, and the generation unit 10a2 generates surrounding colors based on the variation range and number specified on the screen illustrated in FIG. 7.

Furthermore, the above-described systems, programs, and methods may be implemented as a single apparatus or by using parts included in multiple apparatuses, and include various aspects. Further, they can be modified as appropriate, such as a part being software and a part being hardware. Furthermore, the disclosure also holds as a recording medium for a program for controlling an apparatus or system. Naturally, the recording medium for the program may be a magnetic recording medium, a semiconductor memory, or any recording medium developed in the future.

What is claimed is:

1. An information processing apparatus comprising:
an acquisition unit that acquires, from among a plurality of color materials, a specified color material, which is a specified color material, as a parameter for varying color values of color patches; and
a generation unit that generates print data for printing a color chart including a first color patch and a second color patch,
wherein the first color patch and the second color patch differ in usage amount of the specified color material but have the same usage amounts of color materials other than the specified color material.

2. The information processing apparatus according to claim 1, wherein
the acquisition unit accepts, from among components of the color values, a specified component, which is a designated component, as a parameter for varying the color values of the color patches; and
the generation unit generates the print data for printing the color chart by varying a usage amount of the specified color material in the color patches arranged along a first axis and varying a value of the specified component in the color patches arranged along a second axis.

3. The information processing apparatus according to claim 1, wherein
the acquisition unit accepts a reference color that serves as a reference; and
the generation unit generates the print data for printing the color chart including the first color patch and/or the second color patch, with the usage amount of the specified color material being varied with respect to a usage amount of a color material used to print the reference color.

4. The information processing apparatus according to claim 1, wherein
the acquisition unit accepts a variation range for varying the specified color material; and
the generation unit acquires usage amounts of color materials in the first color patch and the second color patch by varying the usage amount of the specified color material by the variation range.

5. The information processing apparatus according to claim 1, wherein the generation unit generates the print data for printing, on the color chart next to the first color patch and the second color patch, a graphic including a portion using the specified color material and not using any color materials other than the specified color material.

6. The information processing apparatus according to claim 1, wherein
the acquisition unit accepts a first specified color material and a second specified color material as the specified color material; and
the generation unit varies a usage amount of the first specified color material in the color patches arranged along a first axis and varies a usage amount of the second specified color material in the color patches arranged along a second axis.

7. A non-transitory computer-readable storage medium storing an information processing program, the program causing a computer to function as:
an acquisition unit that acquires, from among a plurality of color materials, a specified color material, which is a specified color material, as a parameter for varying color values of color patches; and
a generation unit that generates print data for printing a color chart including a first color patch and a second color patch,
wherein the first color patch and the second color patch differ in usage amount of the specified color material but have the same usage amounts of color materials other than the specified color material.
